(19) United States
(12) Patent Application Publication
(10) Pub. No.: US 2025/0131580 A1
(43) Pub. Date: Apr. 24, 2025

(54) INFORMATION PROCESSING APPARATUS AND INFORMATION PROCESSING METHOD

(71) Applicant: JVCKENWOOD Corporation, Yokohama-shi (JP)

(72) Inventor: Yuya TAKEHARA, Yokohama-shi (JP)

(21) Appl. No.: 19/000,977

(22) Filed: Dec. 24, 2024

Related U.S. Application Data
(63) Continuation of application No. PCT/JP2023/020142, filed on May 30, 2023.

(30) Foreign Application Priority Data
Jun. 27, 2022 (JP) 2022-102518

(51) Int. Cl. G06T 7/50; G06T 7/68; G06T 17/00; G06V 20/64

(52) U.S. Cl. CPC G06T 7/50; G06T 7/68; G06T 17/00; G06V 20/64; G06T 2210/62

(57) ABSTRACT

An information processing apparatus is provided that includes: an acquisition unit configured to acquire an image including a specific object as a subject; and a generation unit configured to generate a three-dimensional model of the specific object, based on the image acquired by the acquisition unit, information indicating a shape according to the specific object, and an angle at which a surface of each portion of the specific object is captured.

### CROSS REFERENCE TO RELATED APPLICATION

This application is based upon and claims the benefit of priority from International Patent Application No. PCT/JP2023/020142 filed on May 30, 2023, which is based on Japanese patent application No. 2022-102518, filed on Jun. 27, 2022, the disclosure of which is incorporated herein by reference in its entirety.

### BACKGROUND

The present disclosure relates to an information processing apparatus and an information processing method.

Conventionally, there has been known a technology of generating a three-dimensional model of a subject by using image data (for example, see Japanese Unexamined Patent Application Publication No. 2018-063693).

### SUMMARY

However, with conventional techniques, there are some cases where, for example, a three-dimensional model of a subject cannot be appropriately generated.

An object of the present disclosure is to provide an information processing apparatus and an information processing method that can appropriately generate a three-dimensional model of a subject.

In a first aspect according to the present disclosure, an information processing apparatus is provided that includes: an acquisition unit configured to acquire an image including a specific object as a subject; and a generation unit configured to generate a three-dimensional model of the specific object, based on the image acquired by the acquisition unit, information indicating a shape according to the specific object, and an angle at which a surface of each portion of the specific object is captured.

In a second aspect according to the present disclosure, an information processing method is provided that includes: acquiring an image including a specific object as a subject; and generating a three-dimensional model of the specific object, based on the acquired image, information indicating a shape according to the specific object, and an angle at which a surface of each portion of the specific object is captured.

### BRIEF DESCRIPTION OF THE DRAWINGS

FIG. 1 shows an example of a configuration of an information processing apparatus according to an embodiment;

FIG. 2 shows an example of a hardware configuration of the information processing apparatus according to the embodiment;

FIG. 3 is a flowchart showing an example of processing by the information processing apparatus according to the embodiment;

FIG. 4 shows an example of a guiding model DB according to the embodiment; and

FIG. 5 shows an example of information indicating symmetric properties between a plurality of portions of an object corresponding to a specific type of desk, according to the embodiment.

### DETAILED DESCRIPTION

A principle of the present disclosure is described with reference to several illustrative embodiments. It is to be understood that the embodiments are described only for illustrative purposes, without suggesting any limitations related to the scope of the present disclosure, and help persons skilled in the art understand and implement the present disclosure. The disclosure described in the present description can be implemented through various methods other than those described below.

In the following description and claims, all technical terms and scientific terms used in the present description have the same meanings as are generally understood by persons skilled in the art to which the present disclosure pertains, unless otherwise defined.

Hereinafter, the present embodiment is described with reference to the drawings.

### <Configuration>

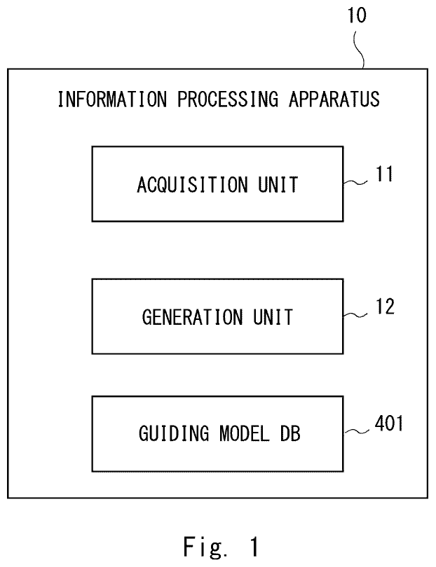

With reference to FIG. 1, a configuration of an information processing apparatus 10 according to the embodiment is described. FIG. 1 shows an example of the configuration of the information processing apparatus 10 according to the embodiment. In the example in FIG. 1, the information processing apparatus 10 includes an acquisition unit 11, a generation unit 12, and a guiding model DB 401. Each of the units may be implemented through cooperation between one or more programs installed in the information processing apparatus 10 and hardware, such as a processor 101 and a memory 102, of the information processing apparatus 10. Note that the information processing apparatus 10 may be an information processing apparatus such as a server, a cloud server, a personal computer, or a smartphone.

The acquisition unit 11 acquires an image that includes a specific object as a subject. Note that “objects” may also include living things, such as humans and animals. The generation unit 12 generates a three-dimensional model of the specific object, for example, based on the image acquired by the acquisition unit 11, information indicating a shape according to the specific object, and an angle at which a surface of each portion of the specific object is captured. The guiding model DB 401 stores a guiding model that is information indicating a shape according to an object.

### <Hardware Configuration>

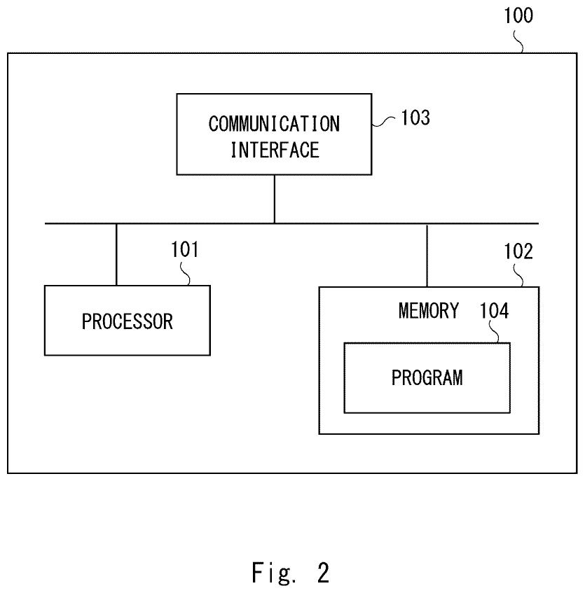

FIG. 2 shows an example of a hardware configuration of the information processing apparatus 10 according to the embodiment. In the example in FIG. 2, the information processing apparatus 10 (computer 100) includes the processor 101, the memory 102, and a communication interface 103. Each of the parts may be connected to the others through a bus or the like. The memory 102 stores at least part of a program 104. The communication interface 103 includes an interface required to communicate with another apparatus, for example, through the Internet, a local network, a bus, or the like.

When the program 104 is executed by the processor 101, the memory 102, and the like cooperating, at least part of processing in the embodiment of the present disclosure is performed by the computer 100. The memory 102 may be of any type. As a non-limiting example, the memory 102 may be a non-transitory computer-readable storage medium. The memory 102 may be implemented by using any of appropriate data storage technologies, such as a semiconductor-based memory device, a magnetic memory device and system, an optical memory device and system, a fixed memory, and a removable memory. Although only one memory 102 is illustrated in the computer 100, several physically different memory modules may exist in the computer 100. The processor 101 may be of any type. The processor 101 may include one or more of a general-purpose computer, a dedicated computer, a microprocessor, a digital signal processor (DSP), and a processor based on, as a non-limiting example, multicore processor architecture. The computer 100 may include a plurality of processors, such as an application-specific integrated circuit chip that is temporally dependent on a clock for synchronization of a main processor.

The embodiment of the present disclosure can be implemented by hardware, a dedicated circuit, software, logic, or a combination of any thereof. Some aspects may be implemented by hardware, while other aspects may be implemented by using firmware or software that can be executed by a controller, a microprocessor, or any other computing device.

The present disclosure also provides at least one computer program product tangibly stored in a non-transitory computer-readable storage medium. The computer program product includes computer-executable instructions, such as instructions included in a program module, is executed by an intended real processor or a device on a virtual processor, and executes processes or a method of the present disclosure. Program modules include a routine, a program, a library, an object, a class, a component, a data structure, and the like that execute a specific task or implement a specific abstract data type. Functionality of a program module may be combined with that of another, or may be divided, as desired in various embodiments. Machine-executable instructions in a program module can be executed locally, or in distributed devices. In the distributed devices, the program module can be installed in both local and remote storage media.

Program codes for executing the method of the present disclosure may be written in any combination of one or more programming languages. The program codes are provided to a processor or a controller of a general-purpose computer, a dedicated computer, or any other programmable data processing apparatus. When the program codes are executed by the processor or the controller, functions/operations in a flowchart and/or a block diagram to be implemented are executed. The program codes are fully executed on a machine, or one or some thereof are executed on a machine and are executed as a stand-alone software package, or one or some thereof are executed on a machine while one or some thereof are executed on a remote machine, or the program codes are fully executed on a remote machine or a server.

The program can be stored by using various types of non-transitory computer-readable media and provided to the computer. The non-transitory computer-readable media include various types of tangible recording media. Examples of the non-transitory computer-readable media include magnetic recording media, magneto-optic recording media, optical disk media, semiconductor memories, and the like. The magnetic recording media include, for example, flexible disk, magnetic tape, hard disk drive, and the like. The magneto-optic recording media include, for example, magneto-optic disk and the like. The optical disk media include, for example, Blu-ray Disc, CD (Compact Disc)-ROM (Read Only Memory), CD-R (Recordable), a CD-RW (ReWritable), and the like. The semiconductor memories include, for example, solid state drive, mask ROM, PROM (Programmable ROM), EPROM (Erasable PROM), flash ROM, RAM (Random Access Memory), and the like. The program may be provided to the computer by using various types of transitory computer-readable media. Examples of the transitory computer-readable media include electrical signals, optical signals, and electromagnetic waves. The transitory computer-readable media can provide the program to the computer through a wired communication line, such as electric wire and optical fiber, or through a wireless communication channel.

### <Processing>

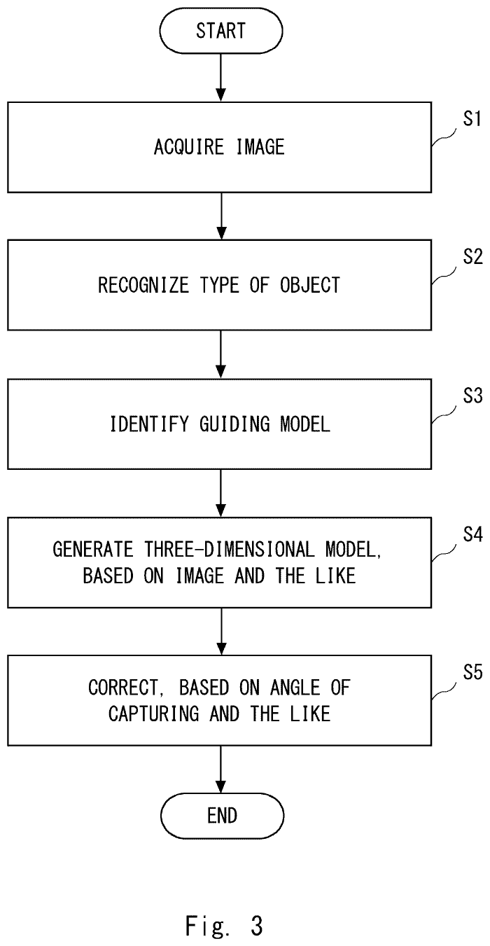

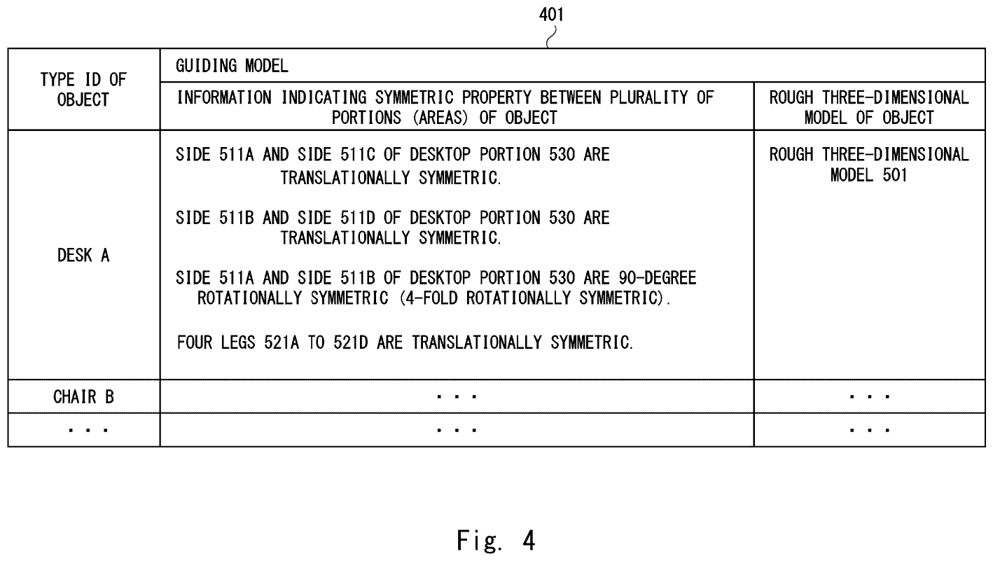

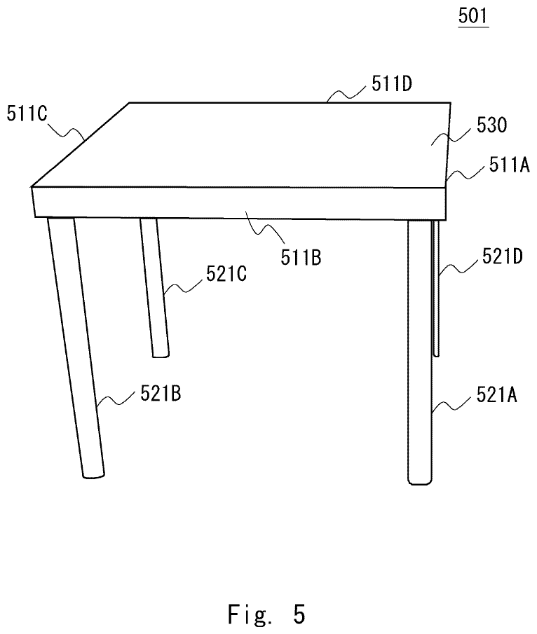

Next, with reference to FIGS. 3 to 5, an example of processing by the information processing apparatus 10 according to the embodiment is described. FIG. 3 is a flowchart showing an example of the processing by the information processing apparatus 10 according to the embodiment. FIG. 4 shows an example of the guiding model DB (database) 401 according to the embodiment. FIG. 5 shows an example of information indicating symmetric properties between a plurality of portions of an object corresponding to a specific type of desk, according to the embodiment. Note that the processing in FIG. 3 may be performed, for example, in response to an operation from a user of the information processing apparatus 10. The information processing apparatus 10 may perform the processing in FIG. 3, with regard to each of a plurality of subjects detected through object detection based on an image.

In step S1, the acquisition unit 11 acquires one or more images including a specific object as a subject. Here, the acquisition unit 11 may acquire one still image captured by an image capturing apparatus (camera). Apart from the image capturing apparatus, the acquisition unit 11 may acquire an image from an internal storage apparatus of the information processing apparatus 10 or an external storage apparatus outside of the information processing apparatus 10, or from the Internet via the communication interface 103. The acquisition unit 11 may acquire a moving image, and may acquire a still image from part of the moving image.

In the image, one target for which a three-dimensional model is generated may be captured, or a plurality of targets may be captured. When a plurality of targets are captured, a three-dimensional model may be generated for all the targets, or for one or some of the targets. To select one or some of the targets, the acquisition unit 11 may automatically select a target captured in the front of the image, or may allow a user to select by presenting the targets thereto.

Subsequently, the generation unit 12 recognizes a type of the specific object, based on the image acquired by the acquisition unit 11 (step S2). Here, the generation unit 12 may recognize the type (for example, desk, chair) of the specific object, for example, by using AI (Artificial Intelligence), such as deep learning.

Subsequently, the generation unit 12 identifies a guiding model corresponding to the specific object (step S3). Here, the generation unit 12 may refer to the guiding model DB 401 and identify the guiding model corresponding to the specific object. In the example in FIG. 4, a guiding model (an example of “information indicating a shape according to the specific object”), which is associated with a type ID of object, is recorded in the guiding model DB 401. Here, the type ID of object is identification information regarding a type of object. A guiding model includes information indicating a symmetric property between a plurality of portions (areas, parts) of an object, and a rough three-dimensional model of the object. Here, for example, for desk, a plurality of desks in different shapes may be recorded in guiding models. The generation unit 12 may present a plurality of guiding models to a user and allow the user to select one guiding model.

The generation unit 12 may identify the guiding model as follows. First, the generation unit 12 recognizes a type of object from the image, and retrieves a type ID of object that coincides with the recognized type of object from among type IDs of object recorded in the guiding model DB 401. When one type ID of object is retrieved, the generation unit 12 identifies a guiding model that is associated with the type ID of object.

When a plurality of type IDs of object is retrieved, the generation unit 12 creates a provisional three-dimensional model from the image. Next, the generation unit 12 selects any one type ID of object among the plurality of type IDs of object, and assumes a guiding model associated with the type ID of object to be a provisional guiding model. The generation unit 12 then compares the provisional three-dimensional model and the provisional guiding model at an angle of capturing the image. At the time, the generation unit 12 fits (enlarges, contracts, rotates, moves) the provisional guiding model to the provisional three-dimensional model, and makes the size and the position of each part represented by the provisional guiding model correspond to those of each part of the provisional three-dimensional model. When the fitted provisional guiding model coincides with the provisional three-dimensional model within a predetermined limit, the generation unit 12 identifies the provisional guiding model as a guiding model. The generation unit 12 not only identifies the provisional guiding model that perfectly coincides with the provisional three-dimensional model as a guiding model, but also may calculate a degree to which the provisional guiding model coincides with the provisional three-dimensional model as a degree of coincidence and identify the provisional guiding model as a guiding model when the degree of coincidence is higher than a predetermined value. The generation unit 12 may use the sum of squares of a distance between corresponding vertices in the two models for the degree of coincidence, and the smaller the value of the sum of squares is, the higher the degree of coincidence is calculated.

When a plurality of type IDs of object is retrieved, and when the guiding model associated with the selected type ID does not coincide with the provisional three-dimensional model within the predetermined limit or when the decree of coincidence is not higher than the predetermined value, the generation unit 12 selects any one type ID of object that has yet to be selected among the plurality of type IDs of object and assumes a guiding model associated with the type ID of object to be a provisional guiding model. The generation unit 12 performs the processing from comparison to degree-of-coincidence calculation as described above with regard to the provisional guiding model, and identifies a guiding model. The generation unit 12 repeats the above-described processing until any one type ID of object that has yet to be selected among the plurality of type IDs of object cannot be selected any more.

The generation unit 12 may calculate a degree of coincidence with regard to all guiding models stored in the guiding model DB 401 and identify one having the highest degree of coincidence as a guiding model. The generation unit 12 may present models having higher degrees of coincidence than a predetermined value to a user and allow the user to select one guiding model.

The information indicating a symmetric property between a plurality of portions of an object is information indicating a symmetric property at a plurality of portions of an object. The information indicating a symmetric property between a plurality of portions of an object may include data that is a combination of information indicating the plurality of portions having a symmetric property and information indicating a type of symmetrical property. The information indicating the plurality of portions having a symmetric property may be, for example, information indicating two or more portions in the rough three-dimensional model of the object. Thus, for example, based on the type of the specific object recognized based on the image, the generation unit 12 can identify the fact that there is a symmetric property between a shape of a certain portion (first portion) of the specific object and a shape of a different portion (second portion) from the first portion.

Types of symmetrical property may include, for example, translational symmetry, rotational symmetry, and reflection symmetry. Note that translational symmetry indicates that, for example, when the certain portion (first portion) in the rough three-dimensional model is parallelly moved, the first portion coincides with the different portion (second portion) from the first portion. Rotational symmetry indicates that, for example, when the first portion is rotated a specified number of degrees of angle, the first portion coincides with the second portion. Note that the information indicating a type of symmetrical property may include information indicating the specified number of degrees of angle in the case of rotational symmetry. Reflection symmetry indicates that, for example, a mirror image of the first portion coincides with the second portion. The first portion and the second portion in the rough three-dimensional model may have different sizes.

A rough three-dimensional model of an object is a three-dimensional model indicating a rough shape of the object. A rough three-dimensional model of an object may include, for example, point cloud data indicating each point (vertex) on surfaces of the object. A rough three-dimensional model of an object may include, for example, data (for example, a surface model) indicating each surface portion of the object. For example, a rough three-dimensional model of an object may be created by the user of the information processing apparatus 10, by combining specific solid figures, such as a cube, a cylinder, a cone, and a sphere. For example, the information indicating a symmetric property between a plurality of portions of an object may be set by the user of the information processing apparatus 10, in association with each solid figure (as metadata on each solid figure).

In an example in FIGS. 4 and 5, it is indicated, in association with a rough three-dimensional model 501, that of four sides 511A to 511D of a desktop portion 530 of a desk A, 511A and 511C are translationally symmetric, 511B and 511D are translationally symmetric, and 511A and 511B are 90-degree rotationally symmetric (4-fold rotationally symmetric). Moreover, it is indicated that four legs 521A to 521D of the desk are translationally symmetric.

Note that the guiding model DB 401 may be recorded in the internal storage apparatus of the information processing apparatus 10. The guiding model DB 401 may be recorded in an external storage apparatus (for example, a DB server) outside of the information processing apparatus 10. In such a case, the information processing apparatus 10 may acquire information recorded in the guiding model DB 401, for example, via the Internet or the like. Note that data recorded in the guiding model DB 401, for example, may be registered by the user of the information processing apparatus 10 or the like.

Subsequently, the generation unit 12 generates a three-dimensional model of the specific object, based on the image acquired by the acquisition unit 11 and the like (step S4). Here, the generation unit 12 may generate the three-dimensional model by using AI or the like, first based on the one still image acquired by the acquisition unit 11. Note that such a process may be executed by using a commonly known technique. When a provisional three-dimensional model is created in step S3, the generation unit 12 may omit to generate a three-dimensional model in step S4 by using the provisional three-dimensional model for the three-dimensional model in step S4.

The generation unit 12 may correct the three-dimensional model generated from the image, based on the rough three-dimensional model included in the guiding model. In such a case, the generation unit 12 may first fit the rough three-dimensional model to the three-dimensional model generated from the image by using a least squares method or the like, while enlarging, contracting, rotating, and moving the rough three-dimensional model, and identify the size and the position of each portion (part) represented by the rough three-dimensional model. Such a process means that the generation unit 12 transforms the rough three-dimensional model in such a manner that the sum of squares of the distance between corresponding vertices in the two models becomes the smallest. For such transformation, the generation unit 12 may perform the processing on each portion in the three-dimensional model, and may use any point instead of a vertex.

The generation unit 12 may round off a fraction, of the three-dimensional model generated from the image, that peeks out of the fitted rough three-dimensional model. In such a case, for example, the generation unit 12 may move a vertex, of the individual vertices of the three-dimensional model generated from the image, that is outside of the fitted rough three-dimensional model, into the fitted rough three-dimensional model. For example, the generation unit 12 may replace a vertex, of the individual vertices of the three-dimensional model generated from the image, that is outside of the fitted rough three-dimensional model, with a vertex, of the individual vertices of the fitted rough three-dimensional model, that is the closest in distance.

Note that the generation unit 12 may refrain from performing rounding-off on a portion, in the three-dimensional model generated from the image, of which any one of degrees of reliability, oppositeness, and clearness, the latter two of which will be described later, is a threshold value or more.

The degree of reliability is a metric indicating a degree to which the generated three-dimensional model is reliable, and one three-dimensional model has one or more values. The closer the direction of a normal line to a surface of the generated three-dimensional model is to the angle of capturing the image, the higher the generation unit 12 calculates a degree of reliability. The generation unit 12 may calculate a degree of reliability for each portion in the three-dimensional model. Here, the angle of capturing the image may be recorded by the acquisition unit 11 when the image is captured, or the generation unit 12 may estimate the angle of capturing from the image. The generation unit 12 may estimate whether or not a shielding object exists between a surface of the generated three-dimensional model and the image capturing apparatus, and calculate a degree of reliability according to a degree of shielding.

Here, the normal line to a surface of the three-dimensional model generated by the generation unit 12 means a surface normal to every surface of the generated three-dimensional model, and one surface has one normal line. However, when the three-dimensional model generated by the generation unit 12 has a curved surface portion or a protruded portion, the generation unit 12 may calculate a plurality of normal lines and select, as a representative, the closest normal line to the angle of capturing the image, from among the plurality of normal lines. The generation unit 12 may collect normal lines to a plurality of surfaces into one normal line even if the generated three-dimensional model has no curved surface portion or protruded portion. For example, the generation unit 12 may select a normal line to a surface having the largest area among the plurality of surfaces, or may calculate an average of the respective normal lines to the surfaces. Here, the average is an average in terms of an angle that a normal line makes with the angle of capturing the image, and the normal line may be a unit normal vector. The generation unit 12 may select a resultant vector, a maximum value, a minimum value, a median value, or a mode value instead of the average, and may use any surface for a representative value. At the time, in the case of the minimum value, there is a tendency that a higher degree of reliability of the generated three-dimensional model is calculated, so that the three-dimensional model is less likely to be corrected, and in the case of the maximum value, there is a tendency that a lower degree of reliability of the generated three-dimensional model is calculated, so that the three-dimensional model is more likely to be corrected.

The generation unit 12 may use a vertex normal for a normal line. When normal lines to a plurality of surfaces are collected into one normal line, the generation unit 12 may use a vertex normal at a vertex shared by a plurality of surfaces. The generation unit 12 may use a surface normal and a vertex normal in combination.

The generation unit 12 may calculate, as a normal line, a normal line from the center of gravity of one surface, or may calculate a center of gravity of a plurality of surfaces collected and use a normal line from the center of gravity. Additionally, the generation unit 12 may calculate a normal line from any point, and may obtain a normal line at each predetermined interval. The generation unit 12 may calculate a tangent plane in contact with a plurality of surfaces and use a normal line from the tangent plane.

Subsequently, the generation unit 12 generates (corrects) the three-dimensional model of the specific object, based on an angle (angle of capturing) at which the surface of each portion of the specific object is captured, and the like (step S5). Thus, for example, when a certain portion of the specific object extends in a depth direction when viewed from the image capturing apparatus, a three-dimensional model of the certain portion can be corrected based on the guiding model.

In such a case, when the angle at which the surface of a specific potion of the specific object is captured satisfies a specific condition, the generation unit 12 may make the specific portion in the three-dimensional model coincide with the rough three-dimensional model. In such a case, for example, when the degree of oppositeness, which indicates a degree to which the surface of the specific portion squarely faces the image capturing apparatus, is a threshold value or less, the generation unit 12 may determine that the angle at which the surface of the specific portion is captured satisfies the specific condition. Then, for example, the generation unit 12 may move a vertex, of the individual vertices of the specific portion in the three-dimensional model generated from the image, that is outside of the fitted rough three-dimensional model, into the fitted rough three-dimensional model. For example, the generation unit 12 may replace a vertex, of the individual vertices of the specific portion in the three-dimensional model generated from the image, that is outside of the fitted rough three-dimensional model, with a vertex, of the individual vertices of the fitted rough three-dimensional model, that is the closest in distance.

The generation unit 12 may generate (correct) the three-dimensional model of the specific object, further based on the information indicating a symmetric property between a plurality of portions of an object. Thus, for example, in a task of generating a three-dimensional model of a target object from one still image, a correction can be made to a three-dimensional model generated through an existing scheme. Accordingly, for example, it is possible to enhance the accuracy of the model generated through the existing scheme, and to increase the amount of information also regarding a portion that is not seen in a still image serving as an input.

In such a case, based on a three-dimensional model of at least part of a first portion that has a first degree of oppositeness in the three-dimensional model of the specific object generated from the image, the generation unit 12 may generate a three-dimensional model of at least part of a second portion that has a symmetric property to the first portion and has a second degree of oppositeness that is lower than the first degree of oppositeness. Thus, for example, based on a three-dimensional model of a portion that faces relatively squarely in the image, it is possible to generate a three-dimensional model of another portion that has a symmetric property to the portion and does not face relatively squarely. Accordingly, it is possible to enhance the accuracy of the three-dimensional model of the other portion.

In such a case, for example, as a representative value (for example, the average value, the median value, or the mode value) of angles of capturing, which are angles between the directions of normal lines to individual regions of a surface of the portion and a direction from the image capturing apparatus to the portion, is smaller, the generation unit 12 may determine a higher degree of oppositeness of the portion. For example, of the first and second portions that have a symmetric property, the generation unit 12 may replace the three-dimensional model of the second portion with the three-dimensional model of the first portion that has a relatively high degree of oppositeness. Note that for the direction from the image capturing apparatus to the portion, the generation unit 12 may calculate, for example, a direction from the image capturing apparatus to the center of gravity of the portion, or a representative value of directions from the image capturing apparatus to the individual regions of the surface of the portion.

Moreover, based on a three-dimensional model of at least part of a first portion of which the degree of clearness in the image is a first degree of clearness in the three-dimensional model of the specific object generated from the image, the generation unit 12 may generate a three-dimensional model of at least part of a second portion of which the degree of clearness in the image is a second degree of clearness that is lower than the first degree of clearness. Note that the degree of clearness is, for example, information indicating a degree to which each portion of the specific object is clearly captured in the image. Thus, for example, based on a three-dimensional model of a portion that is relatively much illuminated in the image, it is possible to generate a three-dimensional model of another portion that has a symmetric property to the portion and is relatively little illuminated. Accordingly, it is possible to enhance the accuracy of the three-dimensional model of the other portion.

In such a case, for example, as a representative value (for example, the average value, the median value, or the mode value) of the degrees of clearness of individual pixels in a region where a certain portion of the specific object appears in the image acquired by the acquisition unit 11 is larger, the generation unit 12 may determine a higher degree of clearness of the certain portion. For example, of the first and second portions that have a symmetric property, the generation unit 12 may replace the three-dimensional model of the second portion with the three-dimensional model of the first portion that has a relatively high degree of clearness. Note that, for example, as at least one of the brightness (illuminance), contrast, and resolution of a certain region in the image is higher, the generation unit 12 may determine a higher value of the degree of clearness of the region.

Here, the acquisition unit 11 may calculate a degree of reliability when capturing an image and acquire the image and the degree of reliability. The acquisition unit 11 may store the image and the degree of reliability in the internal storage apparatus of the information processing apparatus 10. The acquisition unit 11 may calculate degrees of reliability while capturing a moving image, determine a state in which a degree of reliability is high, and acquire the then image and degree of reliability. Further, for an image that does not have information about a degree of reliability, the acquisition unit 11 may calculate a degree of reliability from the image, or may calculate a degree of reliability based on additional information about the image. The degree of reliability here may be replaced with any one of the degree of oppositeness and the degree of clearness.

### <Others>

Conventionally, schemes of generating a three-dimensional model from an image can be classified into those of generating a model from one still image, those using a plurality of images captured from different points of view, respectively, those using a moving image, and the like. Methods of generating a three-dimensional model can be classified into volumetric schemes of generating a model from only information appearing in an image, and parametric schemes of generating a model using also a preset characteristic in shape of a target object.

In the schemes of generating a model from one still image and the like, in a case of a volumetric scheme, although a relatively accurate three-dimensional representation can be expected with regard to a portion that appears in an image, the accuracy of a portion that does not appear in the image (for example, in a depth direction) lowers (a relatively large error occurs), in some cases. Moreover, in the schemes of generating a model from one still image and the like, in a case of a parametric scheme, since analysis of a large amount of data is needed to set a characteristic in shape, the scheme is not one that can be easily used by users. In contrast, according to the technique of the present disclosure, it is possible to appropriately generate a three-dimensional model of a subject. Note that according to the technique of the present disclosure, for example, from one still image in which an office or the like is captured, it is possible to appropriately generate a three-dimensional model of each of one or more objects existing in the office. A generated three-dimensional model may be used, for example, in a metaverse (a three-dimensional virtual space on a computer) and the like.

### <Modified Examples>

Although the information processing apparatus 10 may be an apparatus contained in a single housing, the information processing apparatus 10 of the present disclosure is not limited thereto. Each unit of the information processing apparatus 10 may be implemented, for example, by cloud computing including one or more computers. In such a case, for example, at least part (for example, the process in step S4 in FIG. 3) of the processing by the generation unit 12 may be performed by another apparatus. Such information processing apparatuses are also included in examples of the “information processing apparatus” of the present disclosure.

Note that the present disclosure is not limited to the above-described embodiments, and can be changed as appropriate without departing from the scope of the gist thereof.

The present disclosure is applicable to apparatuses that generate a three-dimensional model of an object, and has industrial applicability.

What is claimed is:

1. An information processing apparatus comprising:
an acquisition unit configured to acquire an image including a specific object as a subject; and
a generation unit configured to generate a three-dimensional model of the specific object, based on the image acquired by the acquisition unit, information indicating a shape according to the specific object, and an angle at which a surface of each portion of the specific object is captured.

2. The information processing apparatus according to claim 1, wherein when the angle at which the surface of a specific portion of the specific object is captured satisfies a specific condition, the generation unit is configured to make the specific portion in the three-dimensional model coincide with the shape according to the specific object.

3. The information processing apparatus according to claim 1, wherein the information indicating a shape according to the specific object includes information indicating that a shape of a first portion and a shape of a second portion of the specific object have a symmetric property.

4. The information processing apparatus according to claim 1, wherein among the three-dimensional models of the specific object generated from the image, the generation unit is configured to generate the three-dimensional model of at least part of a second portion, based on the three-dimensional model of at least part of a first portion of which a degree of oppositeness is a first degree of oppositeness, the degree of oppositeness indicating a degree to which a surface squarely faces an image capturing apparatus, the second portion having a second degree of oppositeness that is lower than the first degree of oppositeness.

5. The information processing apparatus according to claim 1, wherein among the three-dimensional models of the specific object generated from the image, the generation unit is configured to generate the three-dimensional model of at least part of a second portion of which a degree of clearness in the image is a second degree of clearness, based on the three-dimensional model of at least part of a first portion of which the degree of clearness in the image is a first degree of clearness, the second degree of clearness being lower than the first degree of clearness.

6. An information processing method comprising:
acquiring an image including a specific object as a subject; and
generating a three-dimensional model of the specific object, based on the acquired image, information indicating a shape according to the specific object, and an angle at which a surface of each portion of the specific object is captured.
